(19) United States
(12) Patent Application Publication
(10) Pub. No.: US 2005/0154713 A1
(43) Pub. Date: Jul. 14, 2005

(54) Systems and methods for determining document relationship and automatic query expansion

(75) Inventors: Eric J. Glover, North Brunswick, NJ (US); Brian Klock, Forked River, NJ (US)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 10/757,128

(22) Filed: Jan. 14, 2004

(51) Int. Cl. G06F 7/00

(52) U.S. Cl. 707/3

(57) ABSTRACT

Systems and methods are disclosed to search for data responsive to first and second query concepts by generating a first expanded set of results from the first query concept; generating a second expanded set of results from the second query concept; determining an intersecting set of documents from the first and second expanded sets of results; and determining an explanation of a relationship for each document in the intersecting set of documents for each of the first and second query concepts.

### BACKGROUND

Unlike most collections, such as an online library catalog or journal, the World Wide Web (WWW) has minimal barriers to content creation: anyone can be a publisher. Publishers vary in expertise, thus, some pages can be of little or no value to readers. However, unlike the WWW, a typical online database will be homogeneous, with a set of items that do not change over time, such as a specific version of a book. Unlike a book or a journal article, a single web page may change, move to a different URL, or be removed from the web. The dynamic and heterogeneous nature of the web makes it difficult to build effective search systems.

A number of useful and popular search engines attempt to maintain full text indexes of the World Wide Web (e.g. AltaVista (http://www.altavista.digital.com), Excite (http://www.excite.com), HotBot (http://www.hotbot.com), Infoseek (http://www.infoseek.com), Lycos (http://www.lycos.com), and Northern Light (http://www.nlsearch.com)). These web search engines allow a user to enter a keyword query, then return a list of pointers to web pages believed to be ‘similar to the query’ or topically relevant. Not all topically relevant documents are useful. Existing web search engines' failure may result from insufficient coverage, or an inability to identify accurately a document as useful. As a result, a user searching the web with a category-specific need may be unable to find useful documents using a web search engine.

Limitations of the search services have led to the introduction of meta search engines, e.g. MetaCrawler and SavvySearch. A meta search engine searches the Web by making requests to multiple search engines such as AltaVista or Infoseek. Since each major search engine indexes a relatively small amount of the Web, combining the results of multiple engines can return many documents that would otherwise not be found. Even with meta-search engines, search results can still be improved. To illustrate, a user enters a query into a search system, but might not know all of the correct keywords for this search. For example, a user might search for AIDS, but not realize that AIDS stands for Acquired Immune Deficiency Syndrome, and as a result, without a thesaurus, a searcher might miss a portion of the relevant documents.

Additionally, given a pair (or set) of query concepts, a searcher may on occasion want to mine the literature to discover if and how the query concepts are related, and the documents that support this relationship. For example, given two genes, it is desirable to discover that gene G1 codes for protein P1, and protein P1 activates gene G2. However, there may be no document that explicitly says this full relation, there may be documents that describe how G1 codes for P1, and P1 activates G2.

Conventional query expansion and automatic relevance feedback systems have been developed. These systems either re-weight the search keywords, or discover new keywords and use a relatively complex scoring function over the keywords. Unfortunately, these methods require complex document analysis or queries that are overly precise. Also, conventional systems cannot discover relationships between concepts based on retrieved documents.

### SUMMARY

In one aspect, a computer-implemented method to search for data responsive to first and second query concepts includes submitting the first query concept to one or more data sources and receiving a first set of results therefrom; submitting the second query concept to the one or more data sources and receiving a second set of results therefrom; determining an intersecting set of documents from the first and second sets of results; and determining a relationship between the first and second query concepts from the intersecting set of documents.

In another aspect, a method is disclosed to automatically expand the initial result sets by discovering new query terms or phrases and automatically submitting them, then finding the intersection of the expanded result sets.

Advantages of the query expansion system may include one or more of the following. This approach has the advantage of very fast discovery of concept relations where their support may be distributed anywhere in the corporate enterprise (or its accessible data sources). The system can run in almost real-time, and can produce very accurate results for related concepts that could be implicit. These results augment existing analysis tools, such as filling in an existing ontology, or helping to guide drug research. Additionally, the expanded search concepts can be used to assist in the search process. The system is fast and can discover new query terms in real-time, while considering the local collection bias. The system produces a simple scoring function designed to reduce problems associated with broad OR queries, allowing less restrictive querying, which allows the system to be more compatible with remote (potentially uncooperative) data sources such as web search engines, remote databases or other data sources. The system is optimized for short (1-3 terms) or vague queries. The system can easily be adapted to control the type of expansion—i.e. only find documents about “relevant proteins” or “more specific”, among others.

### BRIEF DESCRIPTION OF THE DRAWINGS

The system will be readily discerned from the following detailed description of an exemplary embodiments thereof especially when read in conjunction with the accompanying drawing in which like parts bear like numerals throughout the several views.

FIG. 1A shows an exemplary diagram showing search concept expansion.

FIG. 1B shows an exemplary search system to determine relationships between two search concepts using search concept expansion.

FIG. 2 illustrates in more detail a process for search concept expansion.

FIG. 3A shows an exemplary method for finding the expansion concepts and an exemplary method for relevance assessment of each document in the expanded set.

FIG. 3B illustrates in more detail the on-line operation for FIG. 3A.

FIGS. 4A-4D show various search systems.

### DESCRIPTION

Referring now to the drawings in greater detail, there is illustrated therein structure diagrams for a search system and logic flow diagrams for the processes a computer system will utilize queries to perform various searches. It will be understood that the program is run on a computer that is capable of searching one or more data sources, as will be more readily understood from a study of the diagrams.

In general, the system determines relationships between first and second query concepts C1 and C2. In general, the system operates by submitting the first query concept C1 to one or more data sources and receiving a first set of results therefrom; submitting the second query concept C2 to the one or more data sources and receiving a second set of results. The system determines an intersecting set of documents INT from the first and second sets of results; and determines a relationship between the first and second query concepts from the intersecting set of documents.

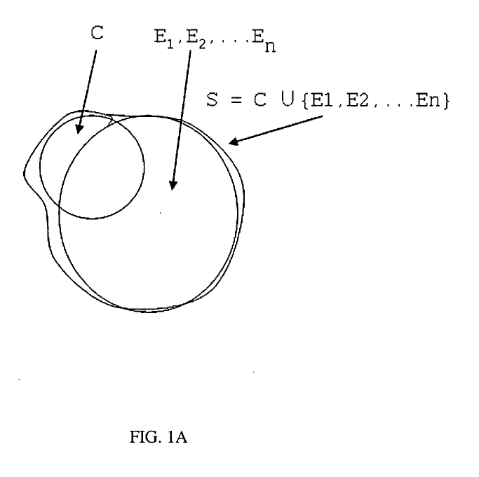

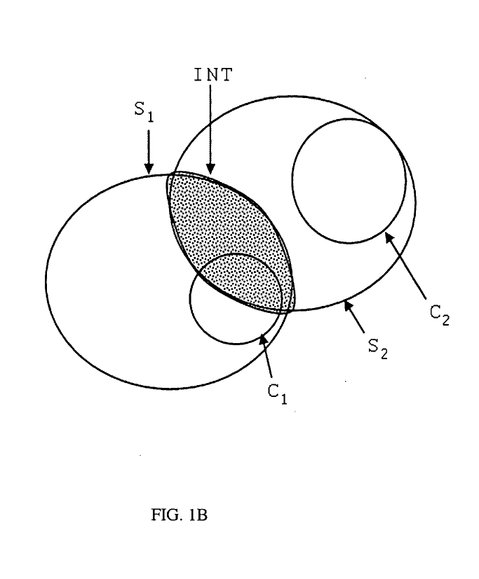

FIG. 1A shows an exemplary diagram showing search concept expansion. The search concept expansion is used to expand a search concept C into one or more expanded concepts E₁, E₂ . . . E_{N}. A union of all results from the searches for the expanded concepts is shown as a set S of relevant documents.

FIG. 1B shows an exemplary search system to determine relationships between two search concepts using search concept expansion. In the embodiment of FIG. 1B, a search system uses the search concept expansion of FIG. 1A and applies the expansion to a first query concept C1 and a second query concept C2 in accordance with the diagram of FIG. 1A. The search system locates data responsive to first and second query concepts by generating a first expanded set of results by searching with the first query concept; generating a second expanded set of results by searching with the second query concept; and determining an intersecting set of documents from the first and second expanded sets of results. The system then provides an explanation of relationships for each document in the intersecting set of documents. In one aspect, the determining the intersection set of documents includes using a product or a combination of relevance scores associated with the first and second query concepts. In another aspect, the method derives the explanation from explanations from the first query concept expansion concepts and from the second query concept expansion concepts.

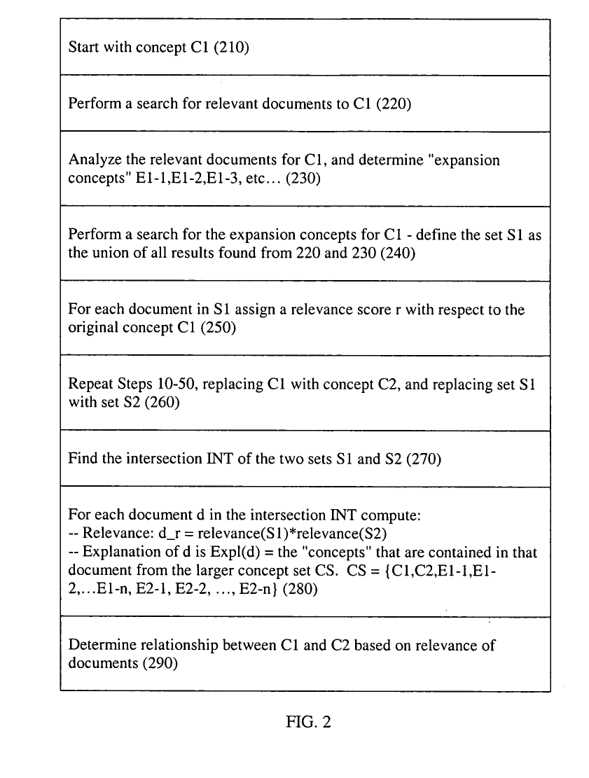

FIG. 2 illustrates in more detail the process of searching with concept expansion. Initially, the process of FIG. 2 receives the first user provided concept C1 (210) and performs a search for documents responsive to concept C1 (220). Next, the process analyzes the relevant documents for C1, and determines “expansion concepts” E1-1, E1-2, E1-3, . . . E1-N (230). The process of FIG. 2 then performs a search for each of the expansion concepts for C1 and generates a set S1 as the union of all results found from operations 220 and 230 (240). Next, for each document in S1, the process assigns a relevance score r with respect to the original concept C1 (250). Operations 210-250 are repeated for the second user provided concept C2 by replacing concept C1 with concept C2, and replacing set S1 with set S2 (260). The process then finds an intersection INT of the two sets S1 and S2 (270). In 280, for each document d in the intersection INT, the process of FIG. 2 computes:
Relevance: d_r=relevance(S1)*relevance(S2)
Explanation of d is Expl(d)=the “concepts” that are contained in that document from the larger concept set CS. CS={C1,C2,E1-1,E1-2, . . . E1-n, E2-1, E2-2, . . . , E2-n}

The relevance score (d_r) is determined over a predetermined threshold from the document set S, together with Expl(d), which is a measure of the concepts from CS found in d, allows the process of FIG. 2 to provide an answer to the question of “How is C1 related to C2 and what documents support this relation?”. A document in the intersection must be found for TWO reasons—one for C1, and one for C2. Each of these provides the specific explanation. Sorting the documents by relevance may be useful in supporting the explanation.

For example, a medical researcher may be interested in searching for a relationship between a concept C1 on “BCL2” and a concept C2 on “heart disease.” The system would perform its search and concept C1 may be expanded to several concepts, one of which may be “apoptosis.” In this example, concept C2 may be expanded to several concepts. The overlapping documents may be found for specific reasons: Documents found from S1 (but in the intersection) might be found because of “apoptosis” and documents found from S2 might be found because of “heart disease”. The explanation is then C1 relates to apoptosis, and apoptosis relates directly to C2 (heart disease). The documents in the intersection are those that explain the relationship.

In one implementation, the types of expansion concepts can be restricted. For example, a search in the biotechnology field can be restricted to only proteins or only genes, among others. In another implementation, the system can alter the expansion method to consider more or fewer concepts—this will tradeoff performance versus result quality. In yet another implementation, the system can perform interactive searches, using the expanded set to find further expansions. Thus, the system can use each of the expanded concepts {Ex_1, Ex_2, . . . Ex_n} as if it were an original concept, and then repeat from the other concept to find the overlapping “subconcepts.”

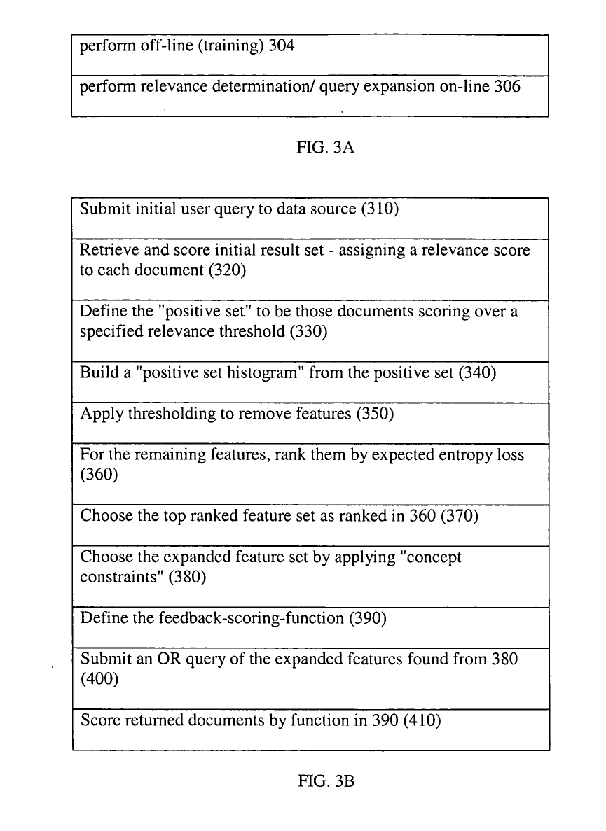

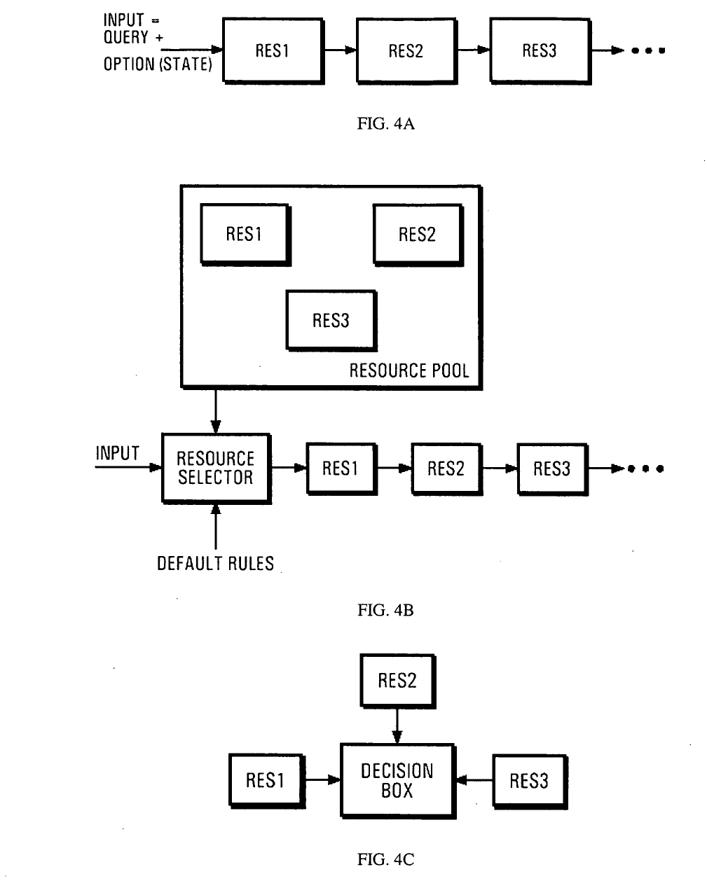

FIG. 3A show an exemplary method for finding the expansion concepts and an exemplary method for relevance assessment of each document in the expanded set to C1. This method includes an off-line (pre-processing) operation 304 and an on-line operation 306. The off-line operation 304 is done ahead of the on-line operation 306. In the off-line operation 304, a background collection histogram for the primary data source is generated. In one embodiment, the background collection histogram is generated through a random sampling of results—such as using several thousand random web pages. This can also be done by analysis of a collection—such as analyzing specialized databases and abstracts. The background histogram is used as a baseline for choosing expansion features—this induced bias is an advantage over methods that do not consider the collection since the relevant expansions clearly depend on the domain. To illustrate, when searching in the networking field, a search term such as “ATM” might mean “Asynchronous Transfer Mode.” However, when searching in the business field, “ATM” might mean “Automatic Teller Machine”.

FIG. 3B illustrates in more detail the on-line operation 366. The process of FIG. 3B receives an initial user query to data source (310). The system performs a search, retrieves documents responsive to the user query, and scores an initial result set by assigning a relevance score to each document (320). The system then defines a “positive set” to be those documents scoring over a specified relevance threshold (330). The system then builds a “positive set histogram” from the positive set (340). Thresholding is also applied to remove features that occur less than a positive threshold in the positive set histogram and occur less than a specified negative threshold in the negative set histogram (350). In this approach, features that occur more frequently in the negative set than the positive set are not used, although this approach could be naturally extended to permit negative query expansions. For the remaining features, the system ranks the features by their expected entropy loss (360). The system then selects the top ranked feature set as ranked in 360 (370). Next, an expanded feature set is selected by applying “concept constraints” (380). In the embodiment of FIG. 3B, the system defines the feedback-scoring-function (390) and submits a query (such as an OR query) on the expanded features found from 380 (400). Additionally, the system scores returned documents by function in 390 (410).

The term “concept constraint” is used herein to refer to some technique for selecting to exclude (or include) features from a ranked list of possible features for expansion. In operation 380's Concept Constraint, not all meaningful expansions are desirable. For example, a searcher might wish to restrict the number of results expected for a given query concept to reduce system load—or a searcher may wish to restrict the type of expanded concept.

Several possible types of “constraints” and corresponding methods are described next. A trivial example might be to exclude features that begin or end with a stopword (such as “the university”). The following are some illustrative specific “tests” that can be used to select (include or exclude) features:

Class: The “class” of the feature might be whether it is, for example, a protein or a person's name, etc. Thus, a specific type of concept can be specified, for example, to only expand to “proteins” or “people”.

Type: Is the feature a title feature, a URL feature, or a full-text. Some expansions may not allow URL constraints/queries.

Frequency: The number of times it occurs in either the positive set histogram or the collection histogram. For example: exclude all features that occur in more than 10,000 negative documents (which can be determined directly from the negative set histogram).

List membership: Specifically include or exclude features on a specific list. For example maybe there is a list of products and product-related features (i.e. color or “battery life”). The list might include features from multiple classes, or a subset of a class.

Pattern match: Features that match (or fail to match) a specific pattern or Regular Expression (REGEX). An example would be were only features that begin with a digit and are 15 characters long (possibly a product ID code) are allowed.

Boolean function: Any Boolean function could be used—such as only allow features where IsChildFeature(f)==true.

Relations to other (possibly already selected) features: For example, when a single term like “lung” is being considered and “lung cancer” is also considered (or already selected), then you might not want two features where one subsumes the other. Selecting the longer phrase might improve precision, making the expansions more specific, while the broader term “lung” or “cancer” might be more general. In other words, the broadness or narrowness of the given query can be specified, for example by specifying that only “more specific concepts” for a query of “breast cancer drugs” should be found.

In one exemplary constraint based on an expected number of results constraint, for performance reasons, the system restricts expansion to exclude overly broad terms. In one method, a negative set histogram can be used to predict the number of documents that contain a given term, and if there are too many documents the concept is excluded. In another embodiment, a set of rules can be used to predict if a given initial phrase satisfies a given type, i.e. a person's name detector. In yet other embodiments, the system uses a model for discovering local concept hierarchies, as described in a co-pending application Ser. No. 10/209,594 filed on Jul. 31, 2002 and entitled “INFERRING HIERARCHICAL DESCRIPTIONS OF A SET OF DOCUMENTS, the content of which is incorporated by reference. This approach works naturally using a positive and collection set histogram and can be applied to a ranked feature list. Other constraints can be used as well.

Although one method in operation 390 has been described, the basic algorithm could work with a different scoring function. The system merely requires that a scoring function be created with the goal of ensuring the relevancy of expanded documents and the original positive set.

In one embodiment to reduce the number of documents retrieved by the query, for all the top ranked features, the system assigns a fixed score to each feature in the set. The system provides a bonus to the features used for expansion, and a bonus to the top ranked features. One method includes: If k features are kept, an initial score of 1/k is assigned to each feature. If j is defined as the number of top ranked features, where j<k, then a bonus of 1/j is assigned to each of the first j features. Then each feature that is part of the expanded set is multiplied by a constant. If there are fewer than k (or j) features, the system adjusts by lowering j and k. The system can also adjust the bonus if too few allowable expansion features are found.

A document is scored by adding the score associated with each feature that is present in the document, and zero for missing features. If the document's score is over some threshold, the document is judged relevant. That threshold can be adjusted based on the desired precision recall balance. This score can be adjusted so it ranges from 0 to 100 (or the same range as an initial relevance function).

In one embodiment, if a feature occurs in none of the positive or negative documents, it is assigned a minimum value to prevent the case of expected entropy loss being penalized. Likewise, if a feature occurs in all of the positive or all of the negative documents, then we assign a maximum value, just less than 100%.

The expanded features are selected by an expected entropy loss to produce features that are generally descriptive of the “positive set”—these features capture the most common theme, so a broad query produces broader expansions, while a more specific query produces specific expansions. For example: A query of “cancer” might produce “carcinoma”, “neoplasm”, “breast” or “prostate” as top ranked features (and possible expansions)—a query of “breast cancer drugs” may produce “tamoxifen” or “paclitel” as expansions. The top ranked features by expected entropy loss are those that are best at separating the positive set from the rest of the world (the collection set). In addition, applying the threshold ensures that rare features (such as misspellings or typos) are not considered. These top ranked features provide a description of the set as a whole—and hence it is expected that a document related to the SET would contain some of all of these top ranked features. By assigning a score to the top ranked features, relevant documents that contain some, but not all, of the expanded features are captured. Likewise, external constraints can be applied to select concepts for expansion, and hence these are deemed more significant—but not significant in isolation. Hence, if a bad expansion feature is used, not all documents are judged as relevant. For example: a query of “skin cancer” applied to a medical database known as Medline produces several expansion concepts including “uv” (for ultraviolet) and “sun”. Not all documents containing “uv” or “sun” are relevant to “skin cancer”, however the frequency of “uv” and “sun” in skin cancer documents is much higher than that of regular Medline documents so they are reasonable expansions. A document that contains “uv”, and none of the other top ranked features (such as melanoma, or “basal cell” or even “skin”), is probably not relevant to skin cancer. However, a document that contains “uv” and “skin” and “cell damage” probably is relevant, even though it might not mention “skin cancer”.

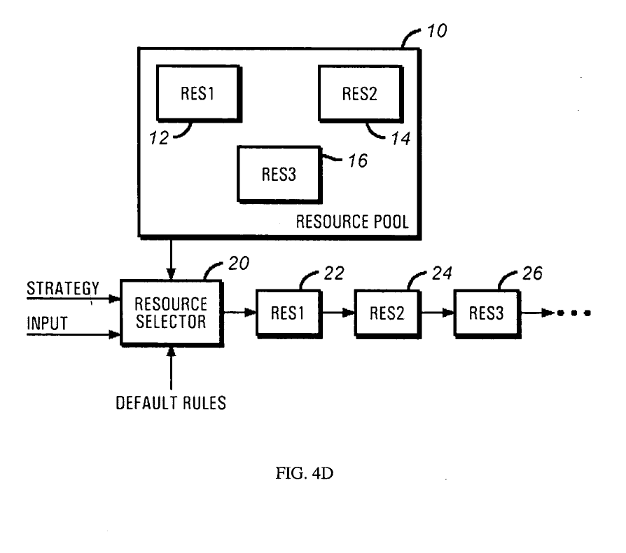

A number of search engines can be used to search the query concepts. FIG. 4A shows a conventional hard-coded search system with three search resources, search resource 1 (RES1), search resource 2 (RES2), and search resource 3 (RES3), among others. In this figure the user's input, which can include a query and options (system state includes options), is processed by a plurality of resources in a pre-defined order. FIG. 4B is another conventional search system that has a similar behavior as FIG. 4A. In this case, the input is provided to a resource selector (“input” includes a query as well as options) with a default selection policy to select the resources RES1, RES2 and RES3. In this case the default selection policy results in the sequencing of same set of resources in the same order as FIG. 4A. Likewise adding RES 4 to the end of the list of FIG. 4A, and to the resource pool of FIG. 4B, and modifying the default selection policy could produce the exact same behavior. FIG. 4B is a different way of implementing the search system characterized by FIG. 4A. FIG. 4C shows another conventional system that uses resource selection. In this system RES1 decides whether to run RES2 or RES3 next. However the decision is hard-coded and although this system may appear to have a behavior similar to a strategy, it is not since the rules are defined in advance. Similarly, in another conventional hard-coded search system, an option decides if the second step is RES2 or RES3. Even though an option decides the selection of RES2 or RES3, this is not strategic searching since the behavior is defined in advance. Although the particular selection of resources might change based on if a condition is true or false, the rules are fixed in advance. FIG. 4D illustrates an embodiment of a strategic search system which is similar to the system of FIG. 4B. The system includes a resource pool 10 with RES1 12, RES2 14, and RES3 16, among others. The resource pool 10 is provided to a resource selector 20 which receives a search input as well as a search strategy. Default search rules are also received by the selector 20. The resource selector 20 in turn selects and sequences resources at run-time as RES1′ 22, RES2′ 24 and RES3′ 26, among others. The system of FIG. 4D changes the fixed behavior of the system of FIG. 4B into a strategic-based system by adding an extra input “search strategy,” which can modify the default selection policy during run-time. In FIG. 4D, information is searched in accordance with a specified strategy for a search system having a plurality of resources and production rules for using, ordering and/or manipulating those resources. Based on the strategy provided to the search system, the search system augments its production rules and dynamically determines at run-time the selection or order of said resources according to said production rules along with the augmented production rules. The search strategy can be specified by the user, or more commonly, specified by a system administrator at configuration time. Strategies could include querying different databases based on user location or profile information, using fallback sources or algorithms when the first attempt to find information fails, or altering the search methodology for particular search types based on past experience. However, unlike a hard-wired approach, where the rules are specified in advance, a strategy only modifies the routing algorithm selections at run-time, it does not explicitly specify a hard-wired course of action (although it could, in general it does not). The subtle difference between a hard-wired system that accepts options and a strategy-based system is important. In the hard-wired case, options could be used to select between a few specific choices—i.e. “use thesaurus if option#1=true”. In the strategy case, there is no code looking for specific options built-into the system, but rather the strategy alters the default behavior by modifying the parameters used by the routing algorithm. In some cases simple options might appear identical to a simple strategy, the difference is in how it is implemented and represented by the system.

In one embodiment, the search strategy is a partially specified set of rules or modifications to the routing defaults for controlling a set of search resources for a given search. Hence, the strategy could be loosely thought of as a language that has a construct called “use your own judgment.” For example: One possible search strategy would be “find documents about topic X, use a thesaurus if necessary and search the web sources and local databases”. Another strategy could be the same except adding: “don't search Google™”, or adding “use the generic relevance function or the web relevance function” and the system automatically determines which is best, such as sending web results to the web relevance function, and non-web results to the generic relevance function. The decision of which results to send to which function was not specified in the strategy (although a strategy could explicitly say that Google™ results go to the generic relevance function). In this context, the user specifies the strategy, and the system determines the tactics. More information on the strategy-based search system is disclosed in co-pending application Ser. No. 10/677,579, entitled “STRATEGY BASED SEARCH” filed Oct. 1, 2003, and Ser. No. 10/494,939 entitled “Efficient Metasearch Engine Architecture”, filed on Apr. 1, 2003, the content of which is hereby incorporated by reference.

The invention has been described in terms of specific examples which are illustrative only and are not to be construed as limiting. The invention may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

From the foregoing disclosure and certain variations and modifications already disclosed therein for purposes of illustration, it will be evident to one skilled in the relevant art that the present inventive concept can be embodied in forms different from those described and it will be understood that the invention is intended to extend to such further variations. While the preferred forms of the invention have been shown in the drawings and described herein, the invention should not be construed as limited to the specific forms shown and described since variations of the preferred forms will be apparent to those skilled in the art. Thus the scope of the invention is defined by the following claims and their equivalents.

1. A computer-implemented method to search for data responsive to first and second query concepts, comprising:
receiving a first set of expanded results generated from a first query concept by utilizing one or more data sources;
receiving a second set of expanded results generated from a second query concept by utilizing the one or more data sources; and
determining an intersection set of documents from the first and second sets of expanded results, such that a relationship can be determined between the first and second query concepts from the intersecting set of documents.

2. The method of claim 1 wherein the relationship between the first and second query concepts is explained by determining for each document those concepts related to the document from a larger concept set, the larger concept set including expansions of the first query concept and the second query concept.

3. The method of claim 1 wherein a first relevance score is assigned to the first set of expanded results and a second relevance score is assigned to the second set of expanded results and wherein a composite relevance score is assigned to the intersection set of documents.

4. The method of claim 3 wherein the composite score is assigned by multiplying the first and second relevance scores.

5. The method of claim 1 wherein the documents are filtered by a relevance score.

6. The method of claim 1 wherein the expanded results are generated by:
defining a first set of documents relevant to the query concept, the first set of documents being a subset of a collection set of documents;
building a first histogram of features from the first set of documents; and
selecting features for an expanded feature set by comparing the first histogram of features with a second histogram of features from the collection set of documents.

7. The method of claim 6 wherein the features in the second histogram are a baseline expansion feature set and the features for the expanded feature set are selected by removing features from the baseline expansion feature set based on how often the features appear in the first histogram.

8. The method of claim 7 wherein the baseline expansion feature set is generated by training on a random data sample.

9. The method of claim 6 wherein the expanded feature set is ranked by expected entropy loss.

10. The method of claim 6 wherein concept constraints are applied to the expanded feature set.

11. The method of claim 6 wherein a feedback scoring function is applied to results generated from the expanded feature set.

12. The method of claim 11 wherein the feedback scoring function assigns a fixed score to each feature and where feature can be assigned different fixed scores.

13. A computer-implemented method for automatic query expansion comprising:
defining a first set of documents relevant to a first query concept, the first set of documents being a subset of a collection set of documents;
building a first histogram of features from the first set of documents; and
selecting features for an expanded feature set by comparing the first histogram of features with a second histogram of features from the collection set of documents.

14. The method of claim 13 wherein the features in the second histogram are a baseline expansion feature set and the features for the expanded feature set are selected by removing features from the baseline expansion feature set based on how often the features appear in the first histogram.

15. The method of claim 14 wherein the baseline expansion feature set is generated by training on a random data sample.

16. The method of claim 13 wherein the expanded feature set is ranked by expected entropy loss.

17. The method of claim 13 wherein concept constraints are applied to the expanded feature set.

18. The method of claim 13 wherein a feedback scoring function is applied to results generated from the expanded feature set.

19. The method of claim 18 wherein the feedback scoring function assigns a fixed score to each feature and where feature can be assigned different fixed scores.

20. A computer-readable medium storing instructions to search for data responsive to first and second query concepts, the medium comprising instructions for:
receiving a first set of expanded results generated from a first query concept by utilizing one or more data sources;
receiving a second set of expanded results generated from a second query concept by utilizing the one or more data sources; and
determining an intersection set of documents from the first and second sets of expanded results, such that a relationship can be determined between the first and second query concepts from the intersecting set of documents.

21. The computer-readable medium of claim 20 wherein the relationship between the first and second query concepts is explained by determining for each document those concepts related to the document from a larger concept set, the larger concept set including expansions of the first query concept and the second query concept.

22. The computer-readable medium of claim 20 wherein a first relevance score is assigned to the first set of expanded results and a second relevance score is assigned to the second set of expanded results and wherein a composite relevance score is assigned to the intersection set of documents.

23. The computer-readable medium of claim 20 wherein the expanded results are generated by:
defining a first set of documents relevant to the query concept, the first set of documents being a subset of a collection set of documents;
building a first histogram of features from the first set of documents; and
selecting features for an expanded feature set by comparing the first histogram of features with a second histogram of features from the collection set of documents.

24. A computer-readable medium storing instructions for automatic query expansion, the medium comprising instructions for:
defining a first set of documents relevant to a first query concept, the first set of documents being a subset of a collection set of documents;
building a first histogram of features from the first set of documents; and
selecting features for an expanded feature set by comparing the first histogram of features with a second histogram of features from the collection set of documents.

25. The computer-readable medium of claim 24 wherein the features in the second histogram are a baseline expansion feature set and the features for the expanded feature set are selected by removing features from the baseline expansion feature set based on how often the features appear in the first histogram.

26. The computer-readable medium of claim 25 wherein the baseline expansion feature set is generated by training on a random data sample.

27. The computer-readable medium of claim 24 wherein the expanded feature set is ranked by expected entropy loss.

28. The computer-readable medium of claim 24 wherein concept constraints are applied to the expanded feature set.

29. The computer-readable medium of claim 29 wherein a feedback scoring function is applied to results generated from the expanded feature set.

30. The computer-readable medium of claim 29 wherein the feedback scoring function assigns a fixed score to each feature and where feature can be assigned different fixed scores.
